(19) United States
(12) Patent Application Publication
(10) Pub. No.: US 2016/0101442 A1
(43) Pub. Date: Apr. 14, 2016

(54) GUN FOR CLEANING BY WAY OF AIR OR A SPRAYED AIR/LIQUID MIXTURE

(71) Applicant: ZELUP, Venissieux (FR)

(72) Inventor: Thomas ISSLER, Verin (FR)

(21) Appl. No.: 14/432,331

(22) PCT Filed: Oct. 2, 2013
(86) PCT No.: PCT/FR2013/052350

§ 371 Date: Dec. 15, 2015

(30) Foreign Application Priority Data
Oct. 3, 2012 (FR) 12 59397

(51) Int. Cl. B08B 3/02; B05B 7/04; B05B 7/14

(52) U.S. Cl. CPC B08B 3/026; B05B 7/1486; B05B 7/0483

(57) ABSTRACT

The invention relates to a gun for cleaning by way of air or a sprayed air/liquid mixture, having: a body (2), from which there extends a butt (3) provided with at least one inlet (5) for a pressurized liquid and an inlet (6) for pressurized air, a mechanism (12) for selecting the operating mode of the gun, interposed on the air circuit (9) and liquid circuit (8) thereof, a device (60) for breaking up the liquid into droplets by throwing the liquid flowing in the liquid circuit (8), and a trigger (14) that controls the selection mechanism (12) and is able to take up a first position closing the outlet nozzle (7) and a second position in which only the air exits through the outlet nozzle (7) or a third position in which the air loaded with droplets exits through the outlet nozzle (7).

The present invention concerns the technical domain of cleaning a surface in the general sense using a powdered liquid.

This invention finds numerous applications for cleaning and/or stripping natural surfaces such as external walls, internal walls, flooring, poles, vehicles and/or parts of vehicles, sports equipment (cart wheels, golf clubs or shoes for example), cycles, horse hooves etc.

In technical terms there exist numerous ways of making a cleaning system using powdered liquid. For example we are familiar with a cleaning system consisting of a pressure pump using liquid like water and connected to a cleaning pipe equipped with a pulverising nozzle using a jet of water. A system like this enables you to clean different surfaces using a powdered jet on this surface. A major drawback of such a system concerns the flow of water necessary to clean or strip a surface. In numerous applications there arises a need to treat water loaded with residue from the cleaning operation. Considering the large quantity of water necessary to ensure proper cleaning of a surface, there arises a major difficulty in treating effluent resulting from this type of cleaning operation.

In an attempt to reduce the consumption of water it is common to resort to a cleaning gun with an air-water mixture with the aim of improving the force of impact with reduced water consumption. This solution is unsatisfactory in practice because the quantity of water used is large and exposes to wetness the surface around cleaned with this mixture. So the surface cleaned and the surroundings become damp, which represents a major drawback for certain cleaning applications.

The present invention aims to remedy technical drawbacks by proposing a new cleaning gun using a powdered liquid designed to limit consumption of the powdered liquid, while not wetting the cleaned surface or its surroundings but maintaining satisfactory quality for cleaning and/or stripping of surfaces.

In pursuit of this aim in line with the invention the cleaning gun comprises:
A body with a handle sticking out equipped with at least one inlet for a liquid under pressure and one inlet for air under pressure, the body being equipped with an exhaust nozzle connected to the liquid and air inlets by ducts of liquid and air, via respectively one exhaust conduit for the air communicating with the exhaust nozzle and an inlet chamber at the centre of which the conduit of exhaust air ends
A mechanism for selecting mode of operation of the gun, positioned on the air and liquid ducts
A device for splitting the liquid into droplets by projection of the liquid circulating in the liquid duct, communicating with the droplet inlet chamber at the exhaust nozzle
A trigger guiding the selection mechanism and suited to occupying one position for the exhaust nozzle, a second position for which air exits only through the exhaust nozzle and a third position for which air loaded with droplets exits via the exhaust nozzle.

The gun in this invention also features one or other of the following additional characteristics:
selection mechanism consisting of a mounted drawer sliding inside the body and equipped with a shutter for the air duct, the drawer being moved by the trigger in an opening direction between its first, second and third positions, so that the shutter occupies a closed air duct position for the first trigger position and an open air duct position for the second and third trigger positions,
a mounted slide sliding into the body and equipped with a shutter for the liquid duct, the slide being moved by the trigger in the open direction between its second and third positions such that the slide shutter occupies the closed and open liquid duct positions for second and third trigger positions respectively,
the slide being involved in flow between the second and third trigger positions by means of the drawer on which the trigger acts,
the slide being equipped at its free extremity with a seat for the air shutter, the slide delineating on the inside an exhaust conduit for air communicating with the exhaust nozzle and the seat for the air duct shutter
the slide being equipped at its other extremity to form the air shutter seat, with a shutter for the liquid duct cooperating with a seat delineating the exhaust nozzle for first and second trigger position
slide and drawer being moved by return spring in a closing direction and not an opening direction
the slide being mounted at least from its extremity equipped with the liquid shutter, on the inside with a drill-hole delineating the slide, a liquid chamber inlet connected to the liquid duct and equipped opposite it, with a wall on which the liquid is sprayed, the wall and slide extremity placed in open position delineating a chamber inlet for droplets to the exhaust nozzle and at the centre of which opens the exhaust air duct
The drawer equipped with the shutter for the air duct is mounted sliding inside with a recess of the body independent of the recess for the slide mounted sliding in the body and equipped with a shutter for the liquid duct
   The trigger is mounted hinged on the body to act on the drawer equipped with the air duct shutter, the trigger being equipped with a finger recoiled with elastic and mounted pivoting on the trigger to act when the trigger occupies its second position, on the slide mounted sliding in the body and equipped with the liquid duct shutter
the handle is equipped with a second inlet for liquid under pressure fitted parallel to the first inlet and connected to the pressure liquid duct by a liaison conduit, a shutter turning selectively being positioned in the liaison conduit and in a part of the liquid duct to connect alternately the liquid duct either to the first inlet or to the second inlet
the body is equipped with an exhaust nozzle carried by an extension mounted on the body.

Another object in the system concerns a cleaning system consisting of:
a gun in line with the invention,
an air feed duct under pressure connected to the air inlet
a liquid feed duct under pressure.

Fortunately the liquid feed duct includes a flow limiter with several pre-set values chosen using a switch.

Various other characteristics emerge from the description appearing below with reference to the attached drawings that show non-exhaustive examples models of the invention.

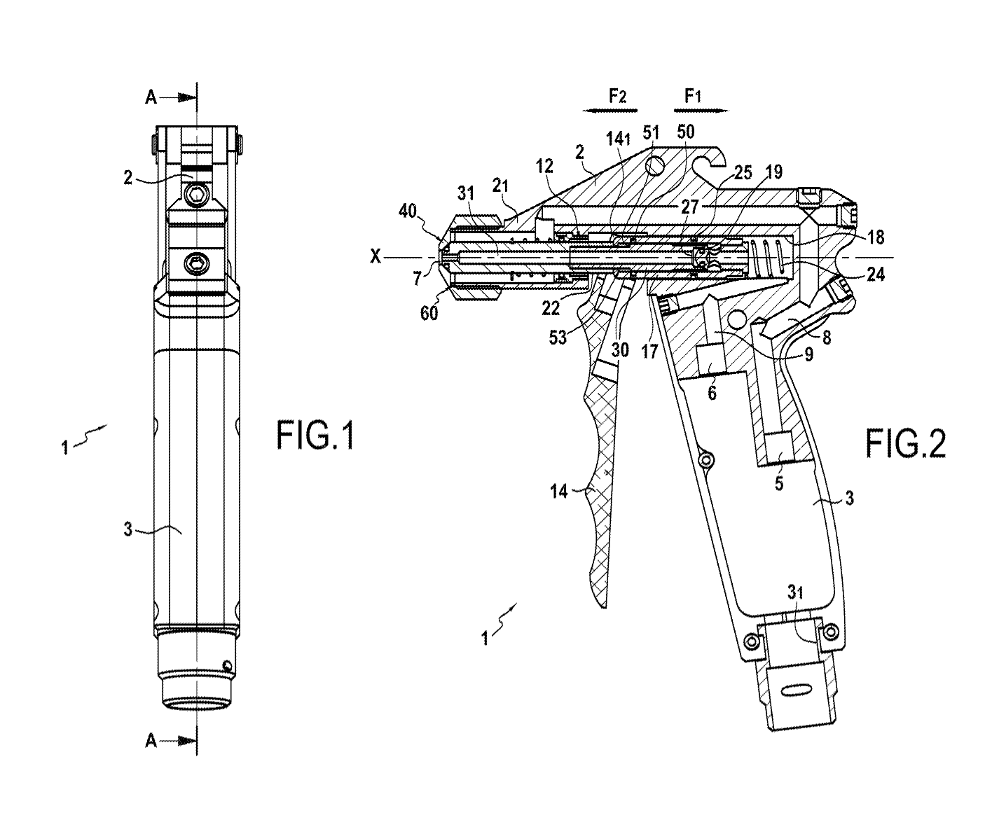

FIG. 1 is a side view with an example of a model of a cleaning gun in line with the invention.

FIG. 2 is a reasonable cross-section view along the lines A-A of FIG. 1 showing the gun in closed position

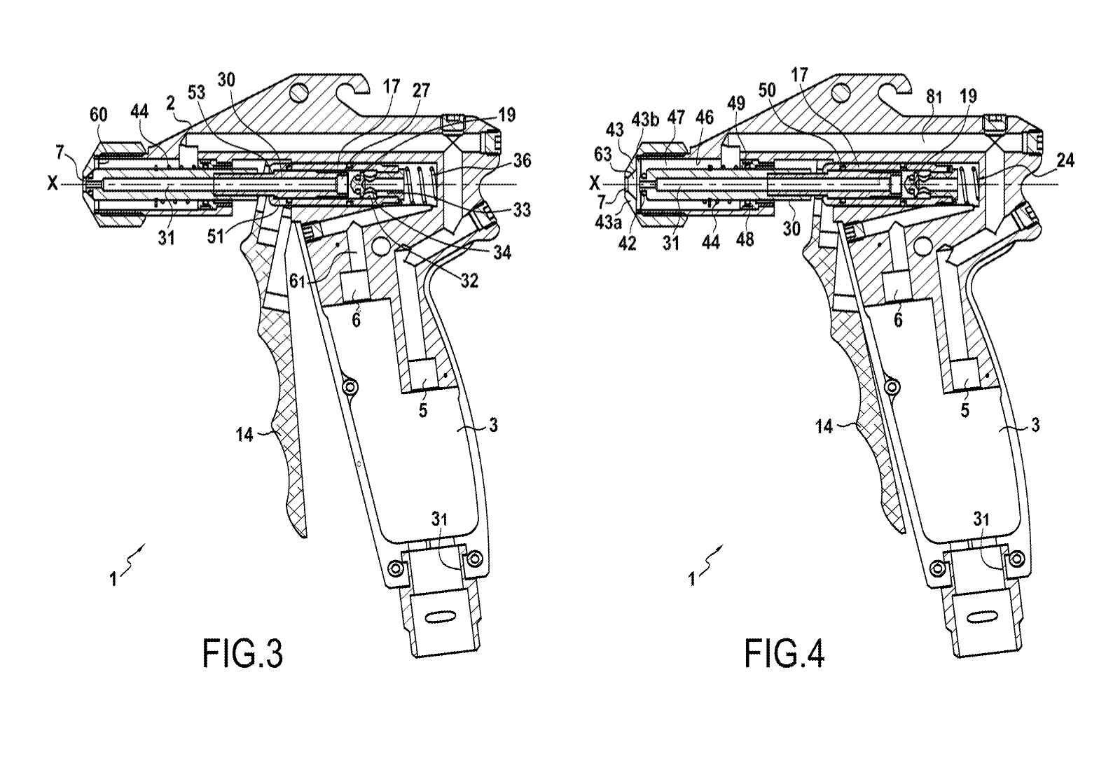

FIG. 3 is a cross-section similar to FIG. 2 showing the gun in air blowing mode only.

FIG. 4 is a cross-section view similar to FIG. 2 showing the gun in pulverising mode with a mixture of air and liquid droplets

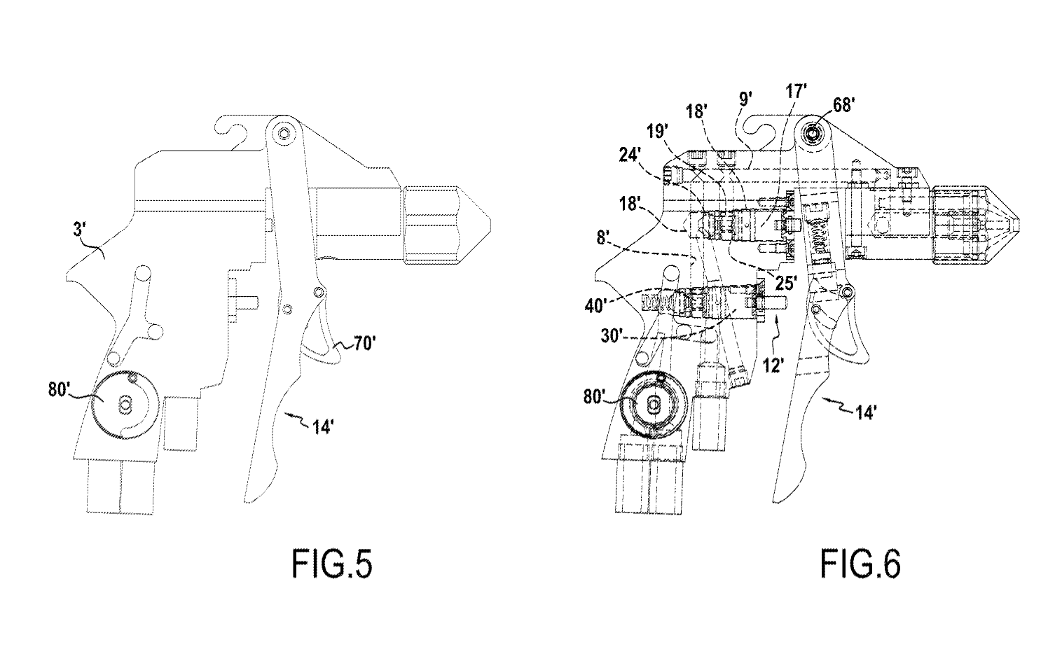

FIG. 5 is a profile view of another example of a model cleaning gun in line with the invention.

FIG. 6 is a profile transparency view of the cleaning gun shown in FIG. 5.

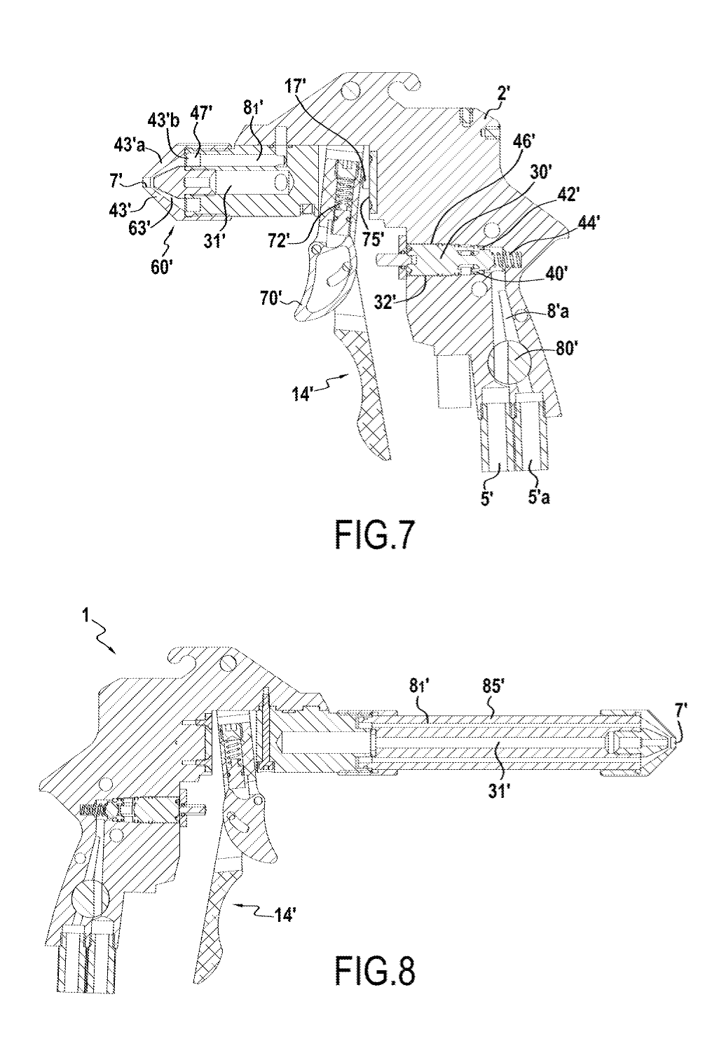

FIG. 7 is a cross-section view of the cleaning gun shown in FIG. 5.

FIG. 8 is a view illustrating another model variant with a gun in line with FIG. 5 and equipped with an extension.

As is more obvious from FIGS. 1 and 2, the object of the invention concerns a cleaning gun 1 consisting of a long flat body 2 extending along a longitudinal X 10 axis from which extends a handle 3. Body 2 is equipped with an inlet 5 for a liquid under pressure and with an inlet 6 for air under pressure. Body 2 equally features an exhaust nozzle 7 fitted in front or at nose 21 of body 2 and communicating with liquid inlets 5 and air inlets 6 using respectively liquid 8 and air 9 ducts fitted in body 2.

Gun 1 includes equally a mechanism 12 for selecting mode of gun operation, positioned on air ducts 9 and liquid ducts 8. This mechanism 12 enables you to select three modes of operation, namely with exhaust nozzle 7 closed, exhaust air only and exhaust with an air-liquid mixture by exhaust nozzle 7.

Gun 1 includes a trigger 14 guiding selection mechanism 12 and suited to occupying a first closed position of exhaust nozzle 7 (FIG. 2), a second position for which air exits only by exhaust nozzle 7 (FIG. 3) and a third position for which an air-liquid mixture exits exhaust nozzle 7 (FIG. 4).

In line with a first preferred variant model shown in FIGS. 1 to 4, selection mechanism 12 includes a sliding drawer 17 mounted inside a shaft 18 fitted in body 2 in line with longitudinal axis X. Drawer 17 is equipped with a shutter 19 for air duct 6 and is moved by trigger 14. To this end body 2 evidences near handle 3 a passage window 22 for the extremity 141 of trigger 14 acting on the front extremity of drawer 17, whose rear extremity is moved by a spring 24 positioned between drawer 17 and the bottom of shaft 18.

In the example shown drawer 17 is moved by spring 24, in such a way as to place drawer 17, without effort applied to trigger 14, in closed position of air duct 9. Drawer 17 is equipped with water-proof joints 25 cooperating with shaft 18. Drawer 17 is thus moved by trigger 14 in an open direction represented by arrow F₁, so that shutter 19 occupies from its closed position shown in FIG. 2 an open position shown in FIG. 3. It is to be noted that in closed shutter position 19 trigger 14 occupies its first position, although in open position of shutter 19 shown in FIGS. 3 and 4 trigger 14 occupies either its second position or its third position.

It is to be noted that trigger 14 continues to move drawer 17 when it passes successively from its first position to the second position and to the third position with a slight rotation of trigger 14. The third position of trigger 14 is defined by stopping trigger 14 against handle 3. On the other hand spring 24 continues to move drawer 17 in a closed direction represented by the arrow F₂, which without any effort on trigger 14 enables trigger 14 to occupy its first position defined by stopping extremity 141 of trigger 14 with shaft 18.

Air shutter 19 is destined, in closed position, to cooperate with a seat 27 fitted to the extremity of a slide 30 whose operation is described more precisely later in the description. Slide 30 shows internally an exhaust duct 31 for air communicating with exhaust nozzle 7 and seat 27.

In the example model shown in FIGS. 1 to 4 air shutter 19 is mounted from the extremity of drawer 17 on which spring 24 acts. In preference drawer 17 shows a tabular form with an internal drill-hole 32, in which are mounted slide 30 and air shutter 19. Shutter 19 extends out of sync to the extremity of a socket 33 fixed on drawer 17 and in which passages 34 are fitted radially for air ensuring a communication between internal drill-hole 32 and a chamber 36 situated between the bottom of the shaft 18 and drawer 17. This chamber 36 in which spring 24 is mounted, communicates with air inlet 6 using channel 61 fitted in body 2. Thus in open position of air shutter 19 air passes successively from inlet 6 to exhaust 7, via channel 61, chamber 36, inside of socket 33, passages 34, internal drill-hole 32 of the drawer, seat 27 and exhaust duct 31 fitted inside slide 30.

Selection mechanism 12 equally includes a shutter 40 for liquid duct 8, ordered to move by trigger 14 such that when trigger 14 occupies its first and second positions, liquid shutter 40 closes liquid duct 8. When trigger 14 occupies its third position, liquid shutter 40 opens liquid duct 8.

In the example shown in FIGS. 1 to 4 liquid shutter 40 is carried by the extremity of slide 30, opposite that equipped from seat 27 for air shutter 19 (FIG. 4). To this end the extremity of slide 30 is equipped with a water-proof joint 42 destined to cooperate with front wall 43 of body 2 delineating exhaust nozzle 7 and forming shutter seat 40. Slide 30 is mounted sliding inside body 2 for elastic movement by counter-spring 44 tending to force liquid shutter 40 to closed position.

Slide 30 is mounted to extend inwards at a distance with drill-hole 46 fitted in body 2 and delineating liquid inlet chamber 47 up to exhaust opening 7. 30 Slide 30 cooperates with a water-proof joint 48 carried by a ring 49 mounted into body 2 and on which rests counter-spring 44. A water-proof joint 50 is positioned between slide 30 and drawer 17. Shutter 40 enables opening and closing of liquid duct 8 next to exhaust opening 7. The liquid is thus brought to exhaust opening 7 from liquid inlet 5 using a channel 81 fitted in body 2 and leading to inlet chamber 47.

In so far as emerges from the model example above, slide 30 occupies a closed position from exhaust opening 7 between the first and second trigger positions 14. When trigger 14 moves from its second to its third position, slide 30 is moved to enable liquid shutter 40 to occupy its open position for liquid duct 8. Fortunately movement of slide 30 is ensured by movement of drawer 17, on which trigger 14 acts.

In so far as emerges from FIG. 2, slide 30 is equipped on the outside with 15 a flange 51, which comes in contact with a driving abutment 53 carried by drawer 17. Slide 30 and drawer 17 are positioned such that between the first and the second trigger positions 14 movement of drawer 17 does not involve movement of slide such that shutter 19 moves relative to seat 27. (FIGS. 2 and 3). When trigger 14 occupies its second position, stop 53 of drawer 17 comes in contact with flange 51 of slide 30 (FIG. 3). Movement of trigger 14 from its second to its third position produces movement of drawer 17 in an open direction F₁, which equally cause slide 30 to move in an open direction F₁ by means of stop 53 cooperating with flange 51 of the slide. Movement of slide 30 in open direction F₁ facilitates opening liquid shutter 40. Simultaneous movement of slide 30 and drawer 17 facilitates keeping shutter 19 in open position.

Releasing trigger 14 leads counter-spring 44 to move slide 30 in closed direction F₂ until liquid shutter 40 occupies the closed position of liquid duct 9.

Movement from third position to second position of trigger 14 is facilitated by spring 44 acting on slide 30 with more force than spring 24, so that slide 30 moves drawer 17. Thus in the second position air 5 shutter 19 remains in open position (FIG. 3). Keeping trigger 14 in this second position only enables air to escape through nozzle 7. Continuing to release trigger 14 causes counter-spring 24 to move drawer 17 in closed direction F₂ opposite to open direction, causing air shutter 19 to occupy its closed position. 10

In line with a characteristic of the invention, gun 1 includes a device 60 for splitting the liquid into droplets positioned on liquid duct 8, between exhaust nozzle 7 and liquid inlet 5. Fortunately device 60 can break, split or smash the liquid into droplets by projection of the liquid on a fixed splitting body. The droplets thus created are exhausted via exhaust opening 7 using air coming from air duct 9.

As appears more precisely from FIG. 4, splitting device 60 includes as fixed splitting body front wall 43 of body 2. To be more precise, front wall 43 has a truncated seat 43a extending from exhaust opening 7 and destined to cooperate with joint 42 of liquid shutter 40. This truncated seat 43a is extended by a splitting wall 43b forming the bottom of liquid inlet chamber 47 situated opposite liquid brought in by channel 81. Liquid flows in line with a direction parallel to longitudinal axis X to be thrown on splitting wall 43b extending significantly perpendicular to the direction of movement of the liquid. Throwing liquid on splitting wall 43b facilitates creation of droplets collected by exhaust chamber 63 communicating upstream with inlet 30 chamber 47 and air exhaust conduit 31 and downstream with exhaust opening 7.

This exhaust chamber 63 is thus delineated when slide 30 occupies the open position of fluid duct 21 between the front wall 43 and the extremity of slide 30 fitted with water-proof joint 42. Thus air coming from exhaust conduit 31 which opens at the centre of exhaust chamber 63 to ensure movement of liquid droplets coming from splitting wall.

It is to be noted that exhaust chamber 63 may create lower pressure in relation to chamber inlet 47 so as to create a venturi effect leading to aspiration of the droplets by airflow.

It emerges from the description above that gun 1 enables automatic selection with trigger 14, one and/or another of the operation modes by pressing trigger 14, considering its pivoted mounting around an axis carried by body 2. For example, we may consider pressing hard on trigger 14 to move it from its first to third positions to achieve cleaning by a flow of air and liquid droplets. In this position shown in FIG. 4 the air and liquid shutters are in open position.

Trigger 14 may then be released to its second position. At the time of this 20 release, drawer 17 and slide 30 are moved simultaneously in a closed direction F₂ under the action of counter-springs, facilitating positioning liquid shutter 40 in closed position of liquid duct 8. In this second position of trigger 14, air shutter 19 is kept in open position facilitating blowing of air by exhaust nozzle 7 with the aim of completing the cleaning by drying.

Gun 1 in line with the invention is of course part of a cleaning system consisting of a compressed air feed duct connected to inlet 6 and a duct with a pressurised liquid feed duct connected to liquid inlet 5. To this end handle 3 is equipped with a passage 31 for the liquid and air feed duct cables, in order to connect them to liquid and air inlets 5 and 6 placed side by side.

Liquid feed duct is able to input a liquid under pressure such as water. For example air feed duct presents a flow of air between 100 and 600 l/mn and for example 150 to 250 l/mn and pressure between 4 and 35 bars, in preference of the order of 6-7 bars. Likewise liquid feed duct produces a constant flow between 0.1 and 100 l/h and for example 8 l/h with pressure between 1 and 80 bars and for example 10 bars. In line with a preferred variant model the liquid feed duct includes a flow limiter equipped with a switch facilitating selecting a flow value from several settings. For example the switch enables choice of the following flow values: 7.20 and 40 l/h.

The system in line with the invention using gun 1 calls for very little cleaning liquid. For example the cleaning system consumes 4 to 6 litres of liquid per hour of operation.

FIGS. 5 to 8 show another variant model of cleaning gun 1 in line with the invention including a mechanism 12′ for selecting gun operation mode, different 20 from mechanism 12 of selecting gun operation mode described in relation to FIGS. 1 to 4. In line with this variant model the gun includes the same means as those described in relation to FIGS. 1 to 4, such that these means carry the same characteristic reference “prime”.

As explained above, this mechanism 12′ enables selection of three operation modes, namely closing exhaust nozzle 7,′ exhaust for air only and exhaust with air-liquid mixture, via exhaust nozzle 7′. In line with this variant model drawer 17′ equipped with shutter 19′ for air duct 9′ is mounted sliding inside with a recess 18′ of body independent of recess 32′ for slide 30′ mounted sliding in body 2′ and equipped with shutter 40′ for liquid duct 8′.

In so far as that emerges more precisely from FIG. 6, drawer 17′ is mounted sliding inside with a shaft 18′ fitted in body 2 in line with a longitudinal axis X. Drawer 17′ is equipped with shutter 19′ for air duct 9′ and it is moved by trigger 14′. In closed position air shutter 19′ is destined to cooperate by its water-proof joints 25′ with shaft 18′ that is placed on air duct 9′. Drawer 17′ is equipped with water-proof joints 25′ cooperating with shaft 18′. In its closed position air shutter 19′ closes air duct 9′. When drawer 17′ is moved by trigger 14′, water-proof joints 25′ no longer cooperate with shaft 18′ such that air duct 9′ is open. This air duct 9′ includes exhaust conduit 31′ ending at the level of exhaust nozzle 7′.

Trigger 14′ acts on the front extremity of drawer 17′ with rear extremity moved by spring 24′ positioned between drawer 17′ and the bottom of shaft 18′. In the example shown drawer 17′ is moved by spring 24′, so as to position drawer 17′ without effort applied to trigger 14′, in closed position of air duct 9′.

Drawer 17′ is thus moved by trigger 14′ in an open direction, as already explained such that shutter 19′ occupies from its closed position, an open position. It is to be noted that in closed position of shutter 19′, trigger 14′ occupies its first position and in open position of shutter 19′, trigger 14′ occupies either its second position or its third position.

It is to be noted that trigger 14′ moves drawer 17′ continuously when it passes successively from its first position to its second and third positions. Inversely spring 24′ moves drawer 17′ continuously in a closed direction without application of effort on trigger 14′, in order to bring trigger 14′ to its first position of rest as mentioned, defined as absence of application of effort on trigger 14′, on drawer 17′. Trigger 14′ is mounted to pivot around an axis 68′ carried by body 2′.

Selection mechanism 12′ equally includes a shutter 40′ for liquid duct 8′, carried by the extremity of slide 30′ mounted sliding in body 2′ in a drill-hole 46′ fitted in body 2′ independent of drawer reception shaft 17′. As seen in the figures, slide 30′ and drawer 17′ are positioned in the handle, one above the other, being staggered laterally between them. Slide 30′ is mounted sliding inside body 2 being moved elastically by counter-spring 44′, having a tendency to bring liquid shutter 40′ to a closed position.

Shutter 40′ is positioned on liquid duct 8′ facilitating opening and closing of liquid duct 8′. Liquid is thus brought to exhaust opening 7′ from liquid inlet 5′, using channels 8′₁ fitted in body 2′ and ending in chamber inlet 47′ of liquid up to exhaust opening 7′.

Slide 30′ is ordered in movement by trigger 14′ so when trigger 14′ occupies its first and second positions, liquid shutter 40″ closes liquid duct 8′ by the cooperation of water-proof joints 42′ carried by slide 30′ with drill-hole 46′. When trigger 14′ occupies its third position, liquid shutter 40′ opens liquid duct 8′.

In line with this variant model the third position of trigger 14′ corresponds to the position activated with a finger or with a lever 70′ mounted pivoting on trigger 14′ to be suited to act on slide 30′ only when trigger occupies its second position. To this end the second trigger position is defined by stop 75′ carried by body 2′. In this stop position of trigger 14′ lever 70′ may be activated to move slide 30′ in an effort to open liquid duct 8′. Finger or lever 70′ is brought elastically to its position of rest by a spring 72′ mounted on trigger.

Gun 1 in line with this variant model equally includes a device 60′ for splitting the liquid into droplets, positioned on liquid duct 8′ between exhaust nozzle 7′ and liquid inlet 5′. As explained above, splitting device 60′ includes as body of fixed splitting front wall 43′ of body 2′. To be more precise, front wall 43′ has a truncated connection part 43′a with nozzle 7′ extended by splitting wall 43′b forming the bottom of chamber liquid inlet 47′, situated opposite liquid inlet brought by channel 8′₁. The liquid flows in a direction parallel to longitudinal axis to be thrown on splitting wall 43′b extending significantly perpendicular in relation to direction of movement of the liquid. Projection of liquid on splitting wall 43′b facilitates creation of droplets collected by an outlet chamber 63′ communicating upstream with chamber inlet 47′ and air exhaust conduit 31′ and downstream with exhaust opening 7′. Thus air coming from exhaust conduit 31′ opening at centre of exhaust chamber 63′ ensures movement of liquid droplets coming from splitting wall.

In line with a good variant model handle 3′ is equipped with a second inlet 5′a for a liquid under pressure fitted parallel to first inlet 5′. This second inlet 5′a is connected to liquid duct 8′ by a liaison conduit 8′a. A selective turning shutter 80′ is positioned in liaison conduit 8′a and in a part of liquid duct 8′ to selectively connect liquid duct 8′ either to first inlet 5′ or second inlet 5′a. This selective turning shutter 80′ contains a manoeuvre organ ending outside handle 3′. Of course this selective turning shutter 80′ may be activated in the variant model shown in FIGS. 1 to 4. In line with a variant model shown in FIG. 8, nozzle 7′ is carried by an extension 85′ mounted on body 2′ by any appropriate means.

1. Cleaning gun using air or a powdered air and liquid mixture is characterised by including:
a body from which extends a handle equipped with an inlet for liquid under pressure and with one inlet for air under pressure, the body being equipped with an exhaust nozzle connected to the liquid and air inlets respectively by liquid and air ducts via respectively an exhaust conduit for air communicating with exhaust nozzle and a chamber inlet at the centre of which opens air exhaust conduit
a mechanism for selecting mode of gun operation, positioned on air and liquid ducts
a device for splitting the liquid into droplets by projection of the liquid circulating in liquid duct communicating with chamber inlet droplets to exhaust nozzle
and a trigger guiding selection mechanism and suited to occupy a first closed position for exhaust nozzle, a second position where air exits only by exhaust nozzle or a third position where air loaded with droplets exits by exhaust nozzle.

2. Gun in line with claim 1, characterised in that selection mechanism includes a drawer mounted sliding inside the body and equipped with a shutter for air duct, drawer being moved by trigger in an open direction between its first, second and third positions such that shutter occupies a closed position for air duct for the first position of the trigger and an open air duct position for the second and third trigger positions.

3. Gun in line with claim 2, characterised in that it includes a slide mounted sliding in body and equipped with a shutter for the liquid duct, slide being moved by trigger in open direction between its second and third positions so that shutter of the slide occupies closed and open positions of liquid duct for respectively the second and third trigger positions.

4. Gun in line with claim 3, characterised in that slide is involved in sliding between the second and third trigger positions by means of drawer on which trigger acts.

5. Gun in line with claim 2, characterised in that slide is equipped at its free extremity with a seat for air shutter, slide delineating internally an exhaust conduit for air communicating with exhaust nozzle and seat for air duct shutter.

6. Gun in line with claim 2, characterised in that slide is equipped at its opposite extremity with that forming seat for air shutter, with shutter for liquid duct cooperating with a seat (43) delineating exhaust nozzle.

7. Gun in line with claim 2, characterised in that slide and drawer are summoned by counter springs in a closed direction opposite to the open direction.

8. Gun in line with claim 3, characterised in that slide is mounted from its extremity equipped with liquid shutter, inside with a drill-hole delineating with a slide, a chamber inlet of the liquid connected to liquid duct and equipped to the opposite, with a wall on which liquid is sprayed, wall and slide extremity placed in open position delineating a chamber inlet for droplets to exhaust nozzle and at the centre of which opens air exhaust conduit.

9. Gun in line with claim 1, characterised in that drawer equipped with shutter for air duct is mounted sliding to inside with a recess of body independent of recess for slide mounted sliding in body and equipped with a shutter for the liquid duct.

10. Gun in line with claim 9, characterised in that trigger is mounted hinged on the body to act on drawer equipped with shutter for air duct, trigger being equipped with a finger driven elastically and mounted pivoting on the trigger to act when trigger occupies its second position, on slide mounted sliding in body and equipped with shutter for liquid duct.

11. Gun in line with claim 1, characterised in that handle is equipped with a second inlet for a liquid under pressure, fitted parallel to first inlet and connected to liquid duct by a liaison conduit, a shutter turning selectively being positioned in liaison conduit and in a part of the liquid duct for connect selectively liquid duct either to first inlet or to second inlet.

12. Gun in line with claim 1, characterised in that body is equipped with an exhaust nozzle carried by an extension mounted on the body.

13. Cleaning system characterised in that it includes:
a gun in line with claim 1,
an air feed duct under pressure connected to air inlet,
a liquid feed duct under pressure at a value above that of the air and connected to liquid inlet.

14. Cleaning system in line with claim 13, characterised in that the liquid feed duct includes a flow limiter with several pre-set values chosen using a switch.
